(19) United States
(12) Patent Application Publication
(10) Pub. No.: US 2017/0307825 A1
(43) Pub. Date: Oct. 26, 2017

(54) TAPERED OPTICAL FIBER CONNECTIONS

(71) Applicant: Corning Incorporated, Corning, NY (US)

(72) Inventors: Scott Robertson Bickham, Corning, NY (US); Jeffrey Scott Clark, Lindley, NY (US); John David Downie, Painted Post, NY (US); Jason Edward Hurley, Corning, NY (US); Sergejs Makovejs, Manchester (GB); Aramais Robert Zakharian, Painted Post, NY (US)

(21) Appl. No.: 15/486,556

(22) Filed: Apr. 13, 2017

Related U.S. Application Data
(60) Provisional application No. 62/326,196, filed on Apr. 22, 2016.

(51) Int. Cl. G02B 6/255; G02B 6/02; H04B 10/29

(52) U.S. Cl. CPC G02B 6/2551; G02B 6/02019; G02B 6/02014; H04B 10/29

(57) ABSTRACT

An optical fiber connection is provided that includes a first optical fiber defining a first exterior surface and a first effective area. The first fiber defines a first tapered region tapering from a first nominal fiber diameter to a first tapered diameter. A second optical fiber has a second exterior surface and a second effective area less than the first effective area. The second fiber defines a second tapered region tapering from a second nominal fiber diameter to a second tapered diameter and a fiber splice optically coupling the first tapered region of the first fiber to the second tapered region of the second fiber. The first and second tapered regions taper such that the first and second exterior surfaces have a variance from a Gaussian function of less than 25% of the Gaussian function at each point along the first and second exterior surfaces.

This application claims the benefit of priority under 35 U.S.C. §119 of U.S. Provisional Application Ser. No. 62/326,196 filed on Apr. 22, 2016 the content of which is relied upon and incorporated herein by reference in its entirety.

### FIELD

The present disclosure generally relates to the connection of optical fibers having different optical properties, and more particularly, relates to the splicing of optical fibers having different effective areas.

### BACKGROUND

Ultra large effective area (A_{eff}) and ultra-low loss silica-core fibers are used for long-haul submarine links. As a result of lower overall span loss and better tolerance towards nonlinear effects, such fibers allow for higher optical signal-to-noise ratios, therefore enabling longer distances, use of higher-density modulation formats and/or longer span lengths with fewer repeaters. Multiple segments of fiber are typically spliced together, along with one or more repeaters, to achieve long distance telecommunications links. In order to take full advantage of large A_{eff}, or large mode field diameter (MFD), fibers, it should be ensured that power losses associated with splices are minimized. The majority of splices per repeater span are between two large A_{eff} fibers (e.g., Corning® Vascade® EX3000 fibers with A_{eff}˜150 μm²). However, when a splice is performed between fibers with dissimilar A_{eff}s (e.g., between large A_{eff} fibers and low A_{eff} fibers, such as a repeater pigtail) higher splice losses may result due to MFD mismatch. Conventional approaches to reduce the splice loss may utilize a “bridge fiber” with an intermediate A_{eff} (e.g., such as a fiber with an average A_{eff} between that of the large A_{eff} fiber and low A_{eff} fiber) or tapering, but such techniques may still produce unacceptable power losses. Accordingly, new methods of splicing fibers having dissimilar A_{eff}s are desired.

### SUMMARY

According to one embodiment of the present disclosure, an optical fiber connection is provided that includes a first optical fiber defining a first exterior surface and a first effective area. The first fiber defines a first tapered region tapering from a first nominal fiber diameter to a first tapered diameter. A second optical fiber has a second exterior surface and a second effective area less than the first effective area. The second fiber defines a second tapered region tapering from a second nominal fiber diameter to a second tapered diameter and a fiber splice optically coupling the first tapered region of the first fiber to the second tapered region of the second fiber. The first and second tapered regions taper such that the first and second exterior surfaces have a variance from a Gaussian function of less than 25% of the Gaussian function at each point along the first and second exterior surfaces.

According to another embodiment of the present disclosure, an optical fiber connection is provided that includes a first optical fiber defining a first exterior surface and a first effective area of greater than 120 μm². The first fiber defines a first tapered region. A second optical fiber defines a second exterior surface and a second tapered region. The second optical fiber has a second effective area of less than 90 μm² and a fiber splice optically coupling the first tapered region of the first fiber to the second tapered region of the second fiber. The first and second tapered regions tapering such that each of the first and second exterior surfaces defines a portion of a substantially Gaussian function. The Gaussian functions of the first and second exterior surfaces have different full widths at half minimum.

According to another embodiment of the present disclosure, an optical fiber connection is provided that includes a first optical fiber defining a first exterior surface and a first effective area of greater than 120 μm². The first fiber defines a first tapered region. A second optical fiber defines a second exterior surface and a second tapered region. The second optical fiber has a second effective area of less than 90 μm² and a fiber splice optically coupling the first tapered region of the first fiber to the second tapered region of the second fiber, the first and second tapered regions tapering such that the first and second exterior surfaces have a variance from a single Gaussian function of less than 20% of the Gaussian function at each point along the first and second exterior surfaces. The fiber splice is offset from a minimum diameter of the first tapering region.

Additional features and advantages will be set forth in the detailed description which follows, and, in part, will be readily apparent to those skilled in the art from the description, or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated into and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic diagram of an optical transmission link, according to one embodiment;

FIG. 2A is an enlarged view of section IIA of FIG. 1 depicting a tapered spliced region between two optical fibers, according to one embodiment;

FIG. 2B is a tapered fiber splice having a diameter trace overlaid thereon, according to one embodiment;

FIG. 3A depicts multiple simulated large effective area fiber to small effective area fiber traces;

FIG. 3B depicts computed splice losses vs. fiber splice offset from a taper minimum diameter of the fiber traces of FIG. 3A;

FIG. 4A depicts a radial scaling function dependence on the distance along the fiber, computed from the measured diameter variation, normalized to the nominal fiber diameter, according to one embodiment;

FIG. 4B depicts simulated optical power loss across a large effective area fiber to small effective area fiber using the measured taper shape from FIG. 4A;

FIG. 5A depicts simulated large effective area to small effective area taper traces with asymmetric tapers;

FIG. 5B depicts corresponding splice losses computed for the asymmetric taper traces of FIG. 5A;

FIG. 6A depicts refractive index profiles measured at different coordinates along the tapered regions of an optical fiber;

FIG. 6B depicts an enhanced view of a fiber core region of the refractive index profiles of FIG. 6A;

FIG. 7A depicts the effective index profile of a large effective area fiber corresponding to a nominal profile away from a taper; and

FIG. 7B depicts single mode field amplitude and mode field diameters computed for the profiles shown in FIG. 7A.

### DETAILED DESCRIPTION

Additional features and advantages of the invention will be set forth in the detailed description which follows and will be apparent to those skilled in the art from the description or recognized by practicing the invention as described in the following description together with the claims and appended drawings.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

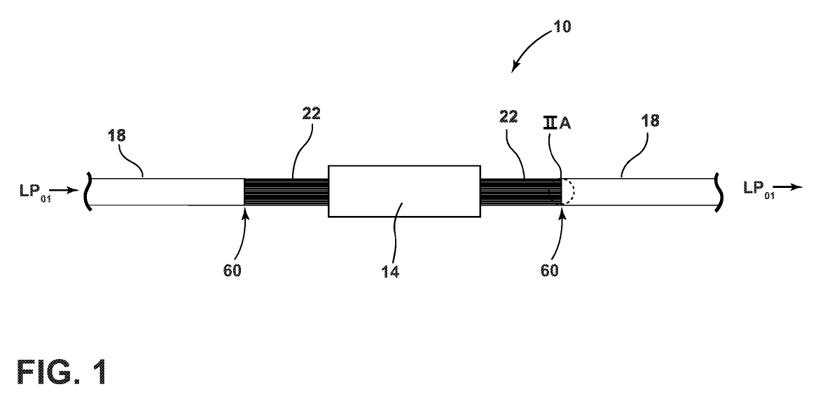

Referring now to FIG. 1, reference numeral 10 generally designates an optical fiber transmission link. The optical fiber transmission link 10 may include a repeater 14, a first optical fiber 18 and a second optical fiber 22. The first and second optical fibers 18, 22 are configured to transmit and propagate light therethrough. The optical fiber transmission link 10 may be used in long distance telecommunications links such as submarine and transoceanic telecommunications systems. The repeater 14 may include an optical single amplification system configured to receive one or more optical signals from the first and second optical fiber 18, 22 and transmit an amplified optical signal. For example, the repeater 14 may include one or more erbium-doped fiber-amplifiers. Further, the repeater 14 may be replaced, or used in conjunction with, optical attenuators, optical isolators, optical switches, optical filters, or multiplexing or demultiplexing devices without departing from the spirit of the disclosure.

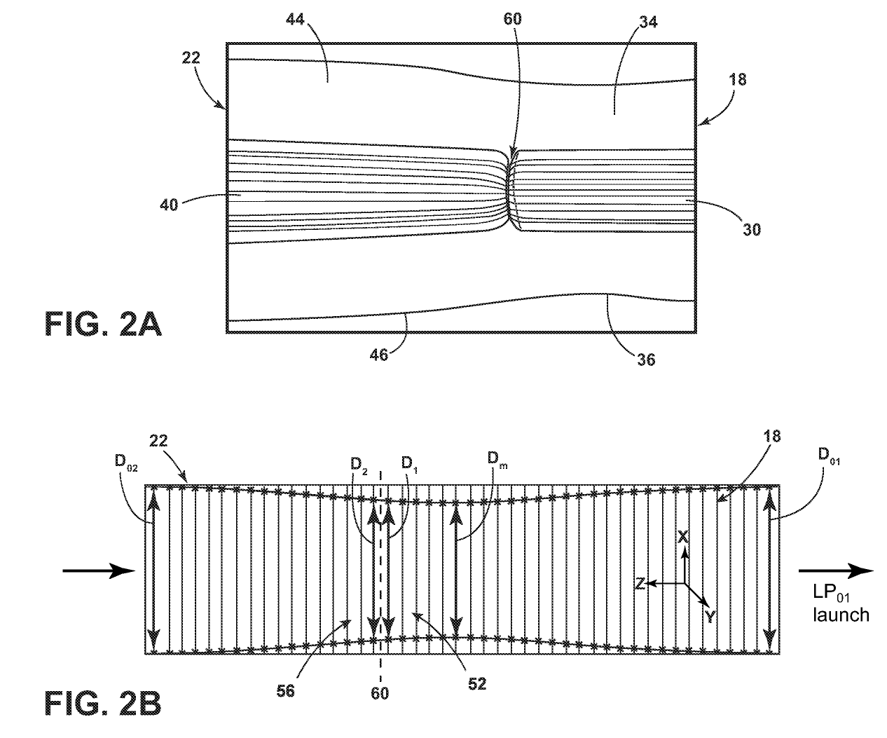

Referring now to FIGS. 1, 2A and 2B, the first optical fiber 18 may include a first core 30 surrounded by a first cladding 34. The first core 30 may be doped with one or more dopants (e.g., GeO₂, P₂O₅, Al₂O₃, Er³⁺, Yb³⁺ and/or Nd³⁺) configured to raise a refractive index of the first core 30. Similarly to the first core 30, the first cladding 34 may be doped with fluorine, B₂O₃ and/or other dopants configured to lower a relative refractive index of the first cladding 34. The first cladding 34 defines a first exterior surface 36 (i.e., an exterior surface of the first cladding 34). It will be understood that one or more jackets, or otherwise protective materials, may surround the first cladding 34 and first exterior surface 36 without departing from the teachings provided herein.

The first optical fiber 18 may be a long haul fiber and as such may extend greater than about 1 km, 5 km, 10 km, or greater than about 20 km. For purposes of this disclosure, a long haul fiber may be a fiber greater than about 1 km in distance. In various embodiments, the first optical fiber 18 may be a long-haul fiber such as Corning® Vascade® EX3000 optical fiber. The first optical fiber 18 may have a first A_{eff} greater than an A_{eff} of the second optical fiber 22, and therefore be considered a large A_{eff} relative to the second optical fiber 22. For the purposes of this disclosure, the terms “large” and “small” denote the relative size of the A_{eff} of the associated optical fiber (e.g., the first and/or second optical fibers 18, 22) relative and bear no relation to an actual size of the A_{eff} of the optical fiber. The A_{eff} of the first and second optical fibers 18, 22 may be calculated as:

A_{eff}=2π(∫f²rdr)²/(∫f⁴rdr),

where the integration limits are 0 to ∞, and f is a transverse component of the electric field associated with light propagated in the optical fibers 18, 22. As used herein, “effective area” or “A_{eff}” refers to optical effective area at a wavelength of 1550 nm unless otherwise noted, and refers to the effective area as measured on the untapered sections of fibers disclosed herein. The first optical fiber 18 may have an A_{eff} greater than about 110 μm², 120 μm², 130 μm², 140 μm², 150 μm², or greater than 160 μm². In a specific example, the A_{eff} of the first optical fiber 18 may be about 150 μm².

The second optical fiber 22 includes a second core 40 and a second cladding 44. The second core 40 and the second cladding 44 may each be doped in a similar manner to that described above in connection with the first core 30 and first cladding 34. The second cladding 44 defines a second exterior surface 46. It will be understood that one or more jackets or otherwise protective materials may surround the second cladding 44 and second exterior surface 46 without departing from the teachings provided herein. The second optical fiber 22 may be a short run fiber and have a length of less than 10 m, 5 m or less than 1 m. For purposes of this disclosure, a short run fiber may be a fiber less than about 10 m in distance. The second optical fiber 22 is spliced to the first optical fiber 18 on one end, as explained in greater detail below, and is coupled to the repeater 14 on an opposite end. As explained above, the second optical fiber 22 may be known as a pigtail. The second optical fiber 22 may be Corning® SMF-28® Ultra optical fiber or other G.652 compliant fiber. In various embodiments, the A_{eff} of the first optical fiber 18 may be greater than the A_{eff} of the second optical fiber 22. For example, the second optical fiber 22 may have an A_{eff} less than about 90 μm², 80 μm², 70 μm², or less than 60 μm². In a specific example, the A_{eff} of the second optical fiber 22 may be between about 78 μm² and about 86 μm².

The first optical fiber 18 may define a first tapered region 52 and the second optical fiber 22 may define a second tapered region 56. The first and second optical fibers 18, 22 may be optically coupled through the first and second tapered regions 52, 56 through a fiber splice 60. Splicing may be utilized to form a continuous optical path between the first and second optical fibers 18, 22 such that optical pulses from one fiber (e.g., the first optical fiber 18) may be transmitted to another fiber (e.g., the second optical fiber 22). The optical pulses travel in a Z-direction axially down the first core 30, through the fiber splice 60, and on through the second core 40. In various embodiments, the optical pulses may be propagated in an LP₀₁ mode, or single mode, through the first and second fibers 18, 22. The fiber splice 60 may be accomplished through either mechanical splicing or fusion splicing of the first and second tapered regions 52, 56. In an exemplary fusion splicing method, ends of the first and second optical fibers 18, 22 are cleaned and positioned in abutting contact with one another. Next, an electrical arc is created across the abutting portion of the first and second optical fibers 18, 22 causing melting and fusion of the fibers 18, 22 to occur. The first and second tapered regions 52, 56 may be formed by offsetting the electrical arc from the fiber splice 60 and pulling the first and second optical fibers 18, 22. The electrical arc may be offset from the ends of the first and second optical fibers 18, 22 (e.g., the fiber splice 60) and the optical fibers 18, 22 drawn, or pulled, to create the first and second tapered regions 52, 56. It will be understood that the steps may be performed in an alternate order. In a specific example of the fusion splicing method, the offset of the electrical arc may be about 35 μm, a time delay after the electrical arc may be set to about 300 ms, a pull speed of the first and second fibers 18, 22 may be set to about 0.75 μm/ms and a pull distance may be set to about 100 μm.

The first tapered region 52 is configured to taper the first optical fiber 18 from a first nominal diameter D₀₁ (e.g., about 125 μm) to a first tapered diameter D₁. The first tapered region 52 may define a minimum tapered diameter Dₘ which is smaller than the first tapered diameter D₁ (i.e., the first tapered diameter D₁ may not be the smallest diameter of the first tapered region 52). In such an example, the first tapered diameter D₁ may be axially offset from the minimum tapered diameter Dₘ. It will be understood that the tapering of the first tapered region 52 of the first optical fiber 18 is of the first exterior surface 36 such that the first nominal diameter D₀₁, the first tapered diameter D₁, and the minimum tapered diameter Dₘ, are expressed as a diameter of the first exterior surface 36. Further, it will also be understood that in some examples the minimum tapered diameter Dₘ may be the same diameter as the first tapered diameter D₁, or that the second tapered region 56 may define the minimum tapered diameter Dₘ. Tapering of the first core 30 may occur and may be proportional to the tapering of the first exterior surface 36 and the first cladding 34.

Similarly to the first optical fiber 18, the second optical fiber 22 defines the second tapered region 56. The second tapered region 56 is configured to taper the second optical fiber 22 from a second nominal diameter D₀₂ (e.g., about 125 μm) to a second tapered diameter D₂. It will be understood that the tapering of the second tapered region 56 of the second optical fiber 22 is of the second exterior surface 46 such that the second nominal diameter D₀₂ and the second tapered diameter D₂ are expressed as a diameter of the second exterior surface 46. Tapering of the second core 40 may occur and may be proportional to the tapering of the second exterior surface 46.

According to various embodiments, the first and second tapered regions 52, 56 may taper such that the first and second exterior surfaces 36, 46 substantially follow one or more first order Gaussian functions. An exemplary Gaussian function may be defined by the following equation:

f(x)=aexp[−(x−b)²/2c²]

where the parameter a is the height of the curve's peak, b is the position of the center of a peak and c is the standard deviation. The shape produced by Gaussian functions may be known as, and referred to, a bell curve. Each of the first and second exterior surfaces 36, 46 of the respective first and second tapered regions 52, 56 may follow the shape of the Gaussian function or bell curve. In other words, the first and second tapered regions 52, 56, may have an axial cross section substantially similar to that governed by a Gaussian function such that when spliced together, the first and second tapered regions 52, 56 have the approximate shape of an inverted bell curve. For example, the first and second exterior surfaces 36, 46 may taper down such that each point along the first and second exterior surfaces 36, 46 substantially follows the Gaussian function.

The diameter of each point along the first and second exterior surfaces 36, 46 may have a variance, or difference, from that prescribed by the Gaussian function that is defined by

v=(1/N)Σᵢ|g(xᵢ)−f(x)|

where g(xᵢ) is the diameter along the taper measured at a series of N discrete axial locations xᵢ, where i is an integer in the range of 1 to N, inclusive. The variance v may be less than about 30%, 25%, 20%, 15%, 10%, 5% or less than about 1% of that of the prescribed diameter according to the Gaussian function. The first and second exterior surfaces 36, 46 may be said to be substantially Gaussian if the variance is less than, or equal to, about 30%. It will be understood that the variance is expressed in terms of an absolute value and that the difference may be either positive or negative. The “peak” of the bell curve may be located at the minimum tapered diameter Dₘ.

The width and depth of Gaussian function may be altered to affect the degree of tapering of the first and second tapered regions 52, 56. The width of the Gaussian function may be expressed in terms of “full width at half minimum” or FWHM, which is related to the standard deviation c by FWHM=2 c (2 ln 2)^{1/2}. Such an expression relates the width of the Gaussian function (e.g., the length of the first and second regions 52, 56) as a function of the peak minimum (e.g., the difference between the fiber diameter and the minimum tapered diameter Dₘ). The Gaussian function may have a full width at half minimum of between about 0.1 mm to about 1.0 mm, or between about 10 μm and about 400 μm or between about 100 μm and about 300 μm. The Gaussian function may have a peak minimum, or difference between a nominal fiber diameter (e.g., the first nominal diameter D₀₁ and/or the second nominal diameter D₀₂) and a minimum diameter (e.g., the minimum tapered diameter Dₘ) of less than about 60 μm, 50 μm, 40 μm, 30 μm, 20 μm or less than 10 μm. The peak minimum of the Gaussian function may be sufficiently large enough that the minimum tapered diameter Dₘ is less than 90%, 80%, 75% or 70% of the first nominal diameter D₀₁. In embodiments utilizing a fiber (e.g., the first and/or second optical fibers 18, 22) having a nominal fiber diameter of 125 μm, the minimum fiber diameter Dₘ may be between about 70 μm and about 110 μm.

According to one embodiment, the first and second tapered regions 52, 56 may each taper such that the first and second exterior surfaces 36, 46 substantially follow a single, or the same, Gaussian function. In other words, the first and second exterior surfaces 36, 46, when spliced together at the fiber splice 60, cooperate to substantially define a bell curve shape across the first and second tapered regions 52, 56. In such an embodiment, the full width at half minimum of the Gaussian function may be between about 100 μm and about 300 μm. Further, the fiber splice 60 may be offset along a common axis (e.g., in the Z-direction) of the first and second optical fibers 18, 22. The fiber splice 60 may be axially offset from the peak of the Gaussian function, minimum tapered diameter Dₘ, or fiber splice 60 by a distance in a range of about 25 μm to about 75 μm, or by greater than about 5 μm, 10 μm, 15 μm, 20 μm, 25 μm, 30 μm, 35 μm, 40 μm or greater than 50 μm. In a specific example, the fiber splice 60 may be offset from the minimum tapered diameter Dₘ by about 35 μm. As explained above, the minimum tapered diameter Dₘ may be located in either the first or second tapered regions 52, 56, but preferentially is located in the fiber with the larger A_{eff} (e.g., the first optical fiber 18).

According to another embodiment, the first and second tapered regions 52, 56 may each taper such that the first and second exterior surfaces 36, 46 substantially follow different Gaussian functions. In such an embodiment, the first and second taper regions 52, 56 may be asymmetric. Further, the fiber splice 60 may be positioned at the peak of the Gaussian function (i.e., each of the first and second tapered regions 52, 56 taper to the minimum tapered diameter Dₘ). In asymmetric embodiments of the first and second tapered regions 52, 56, the Gaussian function of one of the regions (e.g., the first tapered region 52) may have a full width at half minimum of between about 100 μm and about 300 μm. For example, the full width at half minimum may be about 130 μm. The Gaussian function of the other tapered region (e.g., the second tapered region 56) may be between about 10 μm and 100 μm. For example, the full width at half minimum may be about 16 μm or 33 μm. In other words, the Gaussian functions of the first and second exterior surfaces 36, 46 have different full widths at half minimum. The full width at half minimum of the Gaussian function of the first exterior surface 36 may be greater than 200%, 300%, 400% or 500% of the full width at half minimum of the Gaussian function of the second exterior surface 46.

Use of the present disclosure may offer several advantages. First, fiber splices 60 which utilize the first and second tapered regions 52, 56, which substantially follow the same Gaussian function, may have a lower loss of optical power between the first and second optical fibers 18, 22 as compared to conventional fiber splices. For example, an optical power loss of less than 0.2 dB, or less than about 0.15 dB, or between about 0 dB and about 0.2 dB, or between about 0.12 dB and about 0.17 dB, or between about 0.14 dB and about 0.18 dB may be experienced by light transmitted through the first and second tapered regions 52, 56 and the fiber splice 60. In embodiments utilizing asymmetric tapers, the power loss can further be reduced by about 0.02 dB as compared to symmetric tapers. Further, in some embodiments, the fiber splice 60 and first and second tapered regions 52, 56 disclosed herein may need to be used only on an output side, or downstream, of the repeater 14 as the power of the repeater 14 may be increased to account for power loss at a splice on an upstream side of the repeater 14. Secondly, the symmetric and asymmetric tapers disclosed herein may be capable of production via conventional fusion splicers such that splicing system upgrades need not be undertaken. Third, the tapered optical fibers of the disclosure may be utilized in any application where optical fibers having different A_{eff}s (e.g., in data networks or land-based communication systems) are utilized.

### EXAMPLES

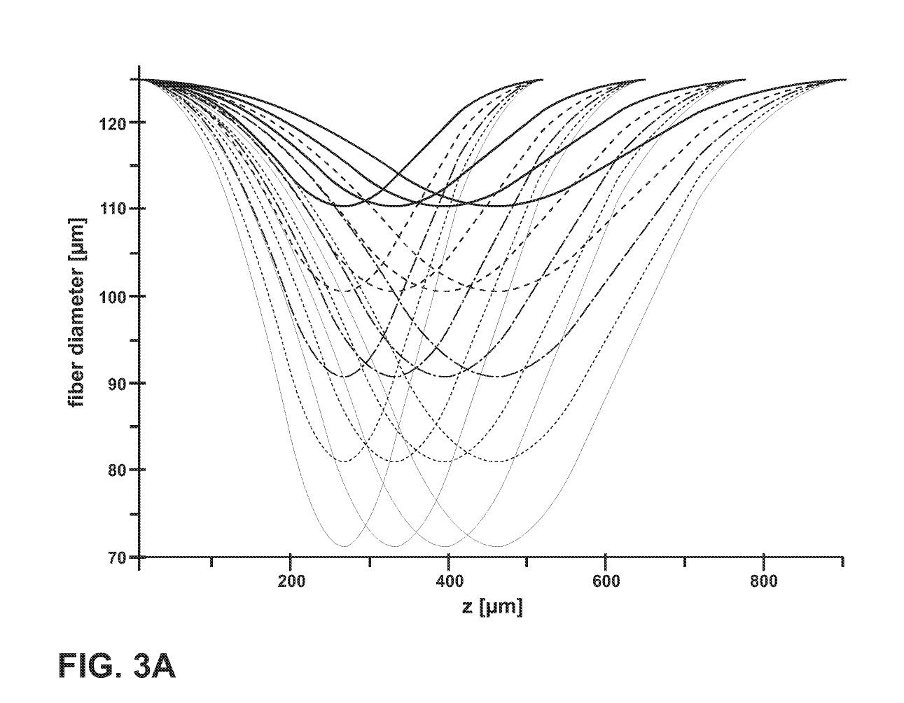

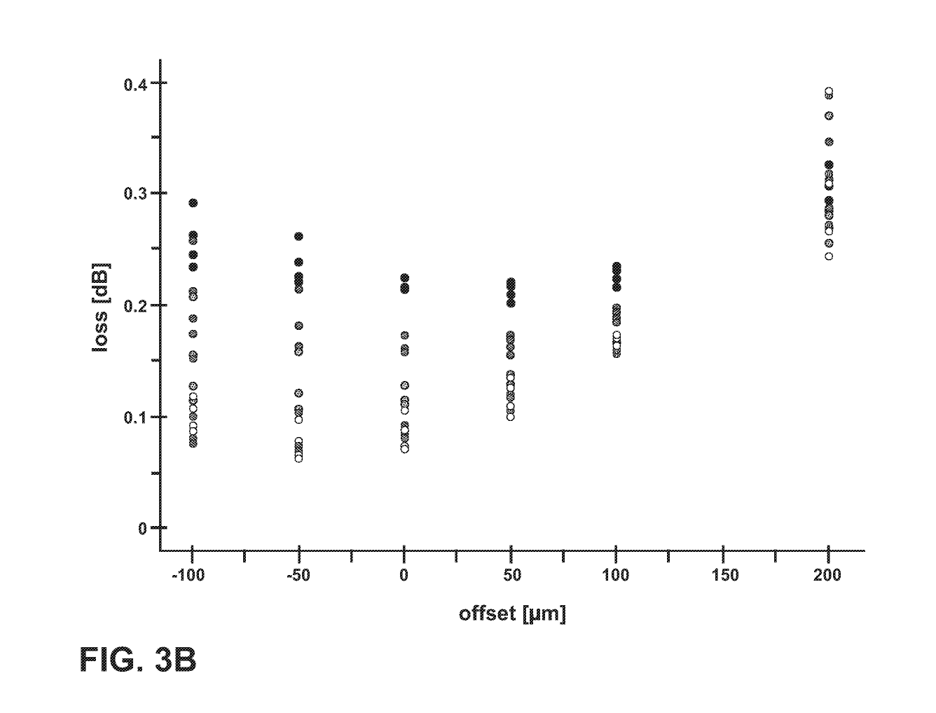

Referring now to FIGS. 3A and 3B, shown is a plurality of taper traces (e.g., of the first and second tapered regions 52, 56) having varying full widths at half minimum and peak minimum as well as the corresponding power loss for each trace at different splice point (e.g., fiber splice 60) offsets from a taper minimum (e.g., the minimum tapered diameter Dₘ). In general, deeper taper traces (i.e. with more dramatic reduction in cladding diameter) may generally lead to smaller splice losses for tapers governed by Gaussian functions having a full width at half minimum of between about 250 μm to about 500 μm.

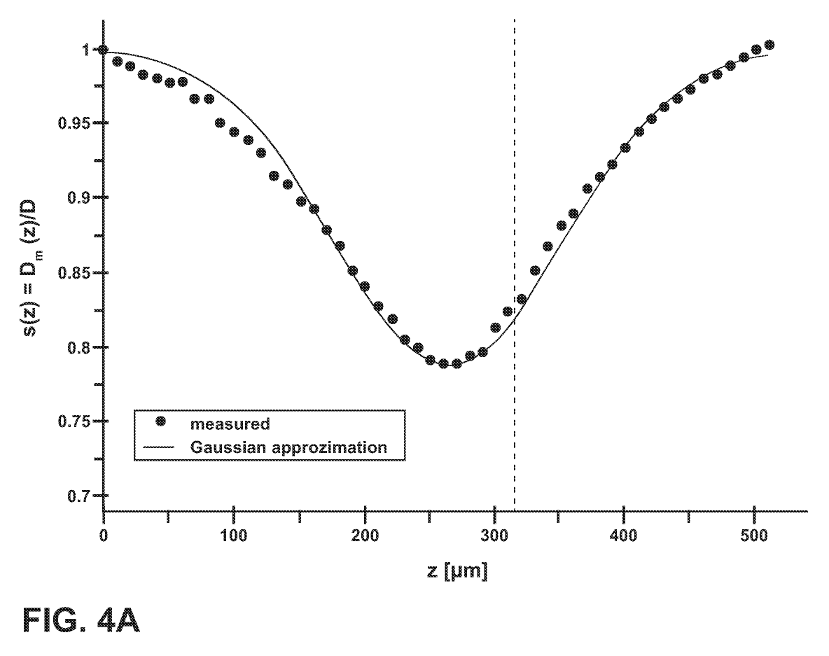

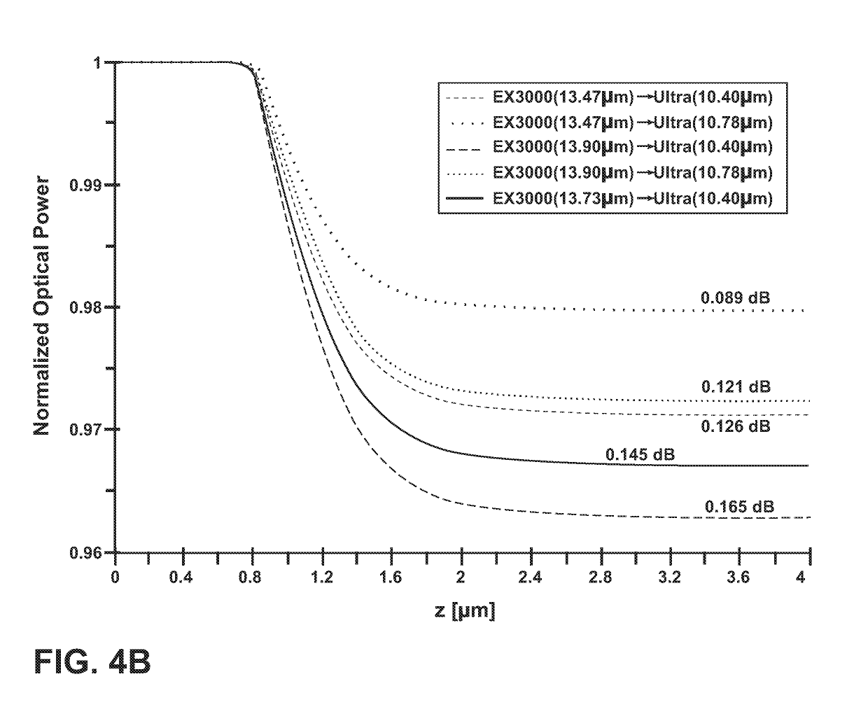

Referring now to FIGS. 4A and 4B, depicted is the measured values of a taper area (e.g., the first and second tapered regions 52, 56) and splice point, expressed in terms of a radial scaling function dependence on the distance along the fiber (e.g., the first and second optical fibers 18, 22) computed from the measured diameter variation, Dₘ(z), normalized to the nominal fiber diameter of 125 μm. A Gaussian function has been overlaid to illustrate fit of the measured values vs the Gaussian function. FIG. 4B depicts simulated optical power loss across a splice between Corning® Vascade® EX3000 (e.g., the first fiber 18) to SMF-28® Ultra (e.g., the second fiber 22) using the measured taper shape from FIG. 4A (i.e., the Corning® Vascade® EX3000 positioned from z=0 μm though z=315 μm). The MFD of the Corning® Vascade® EX3000 and the MFD of the SMF-28® Ultra are varied to simulate the resulting optical power loss for different MFD mismatches.

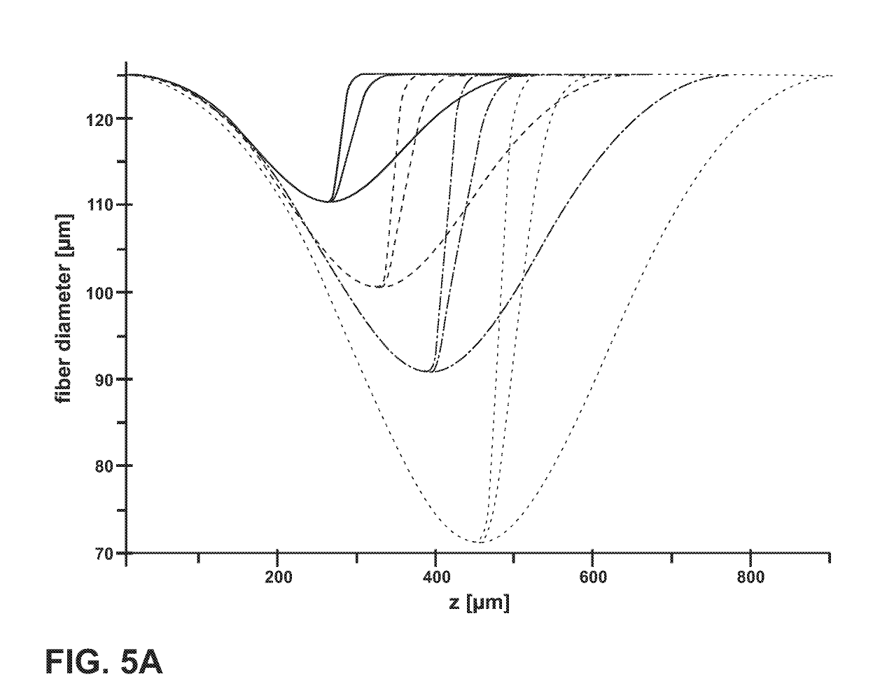

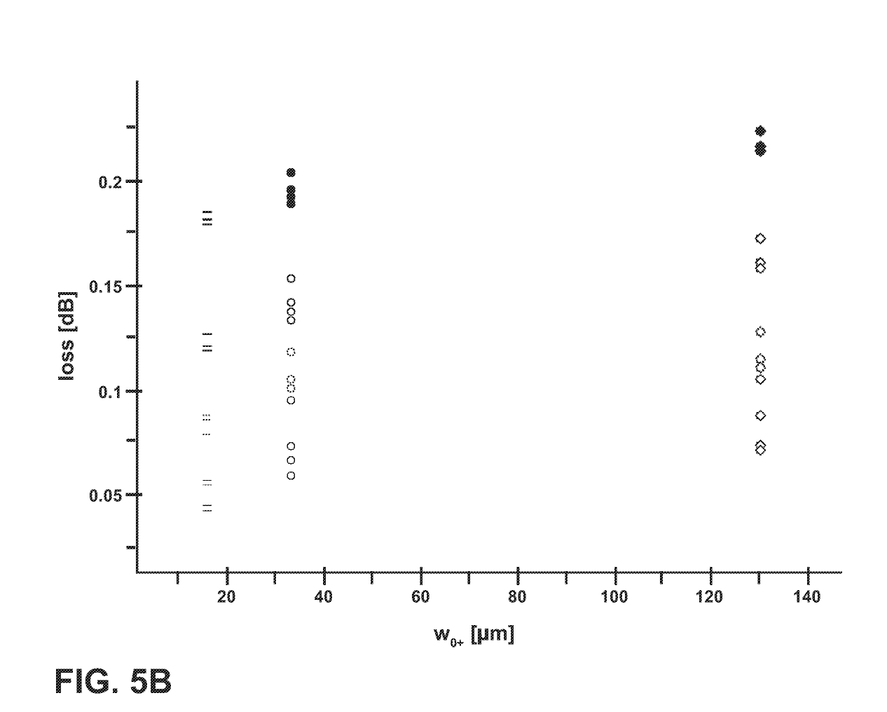

Referring now to FIGS. 5A and 5B, depicted is a plurality of taper traces for asymmetric taper areas (i.e., the full width at half minimum of the Gaussian function of one side of the splice is greater than the full width at half minimum of the Gaussian function of the other side). Such an asymmetric taper may be created by using different pull speeds during the splice (e.g., by linearly accelerating or decelerating the pull speed), or by heat sink designs that affect differentially the fibers on each end of the splice, thus leading to asymmetric taper profiles. FIG. 5B demonstrates computed splice losses for the taper traces of FIG. 5A. The computed splice losses indicate that asymmetric tapers can reduce the splice loss by approximately 0.02 dB, relative to symmetric tapers. One possible reason for an improved splice loss when using an asymmetric taper is due to faster transition from tapered mode of the large A_{eff} fiber to the small A_{eff} fiber, which avoids additional diffraction and leads to better mode overlap. Within the parameter ranges considered in the examples, the overall best splice loss achieved using an asymmetric taper was 0.043 dB. This may allow achievement of lower total splice loss for spans constructed of Corning® Vascade® EX3000 spliced to pigtails composed of G.652 compliant fiber.

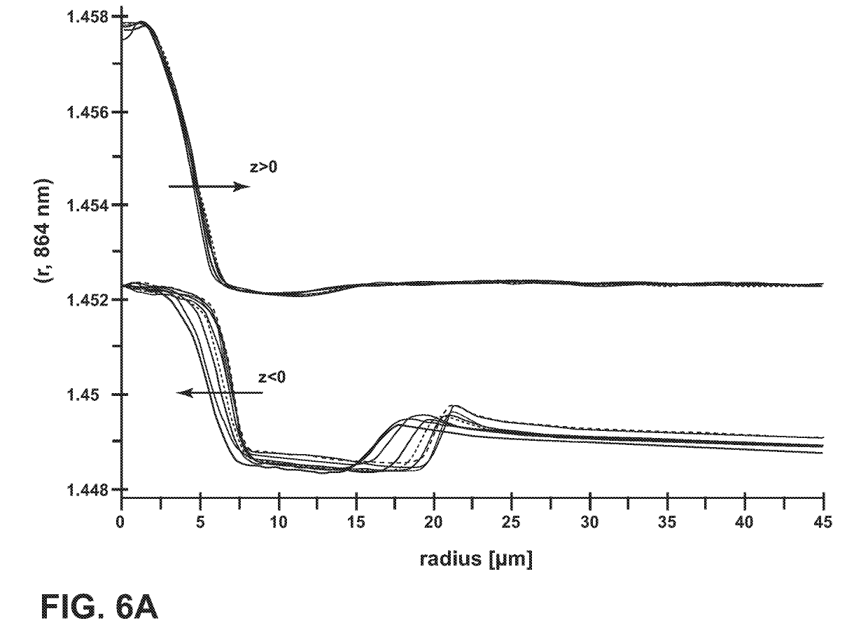

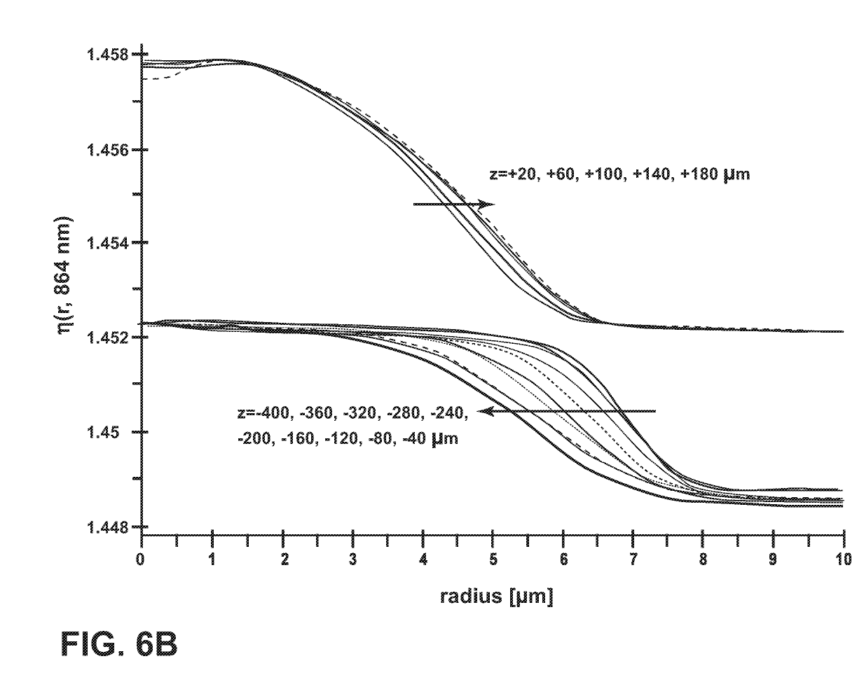

Referring now to FIGS. 6A and 6B, depicted are plots of the refractive index (r) profile measured at different z-coordinates along the tapered splice area. FIG. 6B enlarges a fiber core region of FIG. 6A. The “refractive index profile” is the relationship between refractive index, or relative refractive index, and waveguide fiber radius. In order to evaluate the effect of the dopant diffusion induced by the tapering process at elevated temperatures, the refractive index profiles measured at different points along the tapered region were analyzed. The radial scaling down of the fiber diameter and changes in the shape of the core are both visible in the measured data. The Z<0 values correspond to the EX3000 fiber, with the index profile at z=−400 μm being representative of a nominal Corning® Vascade® EX3000 profile away from the tapered region. The Z>0 coordinates correspond to SMF-28® Ultra fiber, with z=+180 μm being representative of the nominal SMF-28® Ultra fiber profile unaffected by the taper. These measurements support the theory that the dominant effect of the tapering is radial scaling of the fiber cross-sections, with the core-to-cladding index contrast being substantially constant throughout the tapered splice.

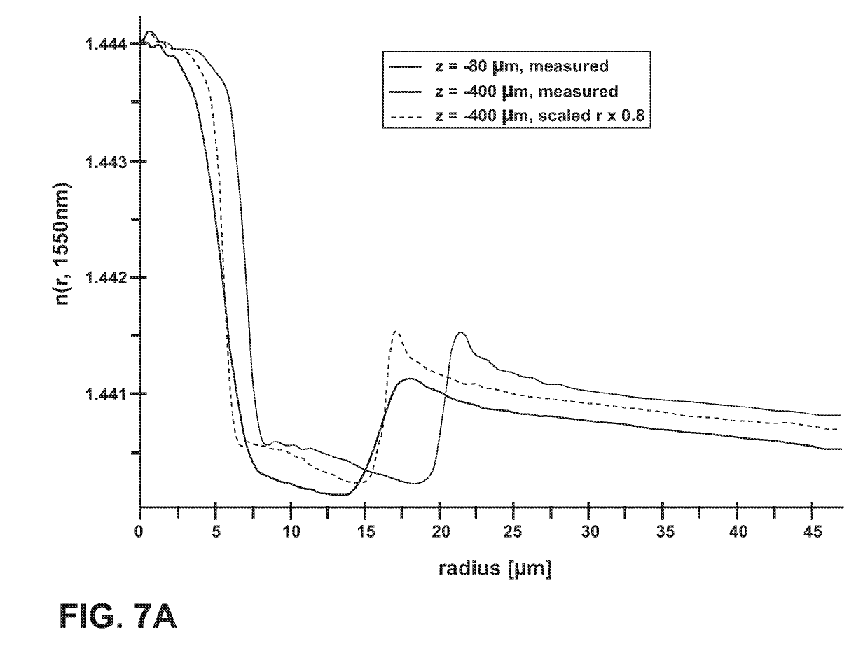

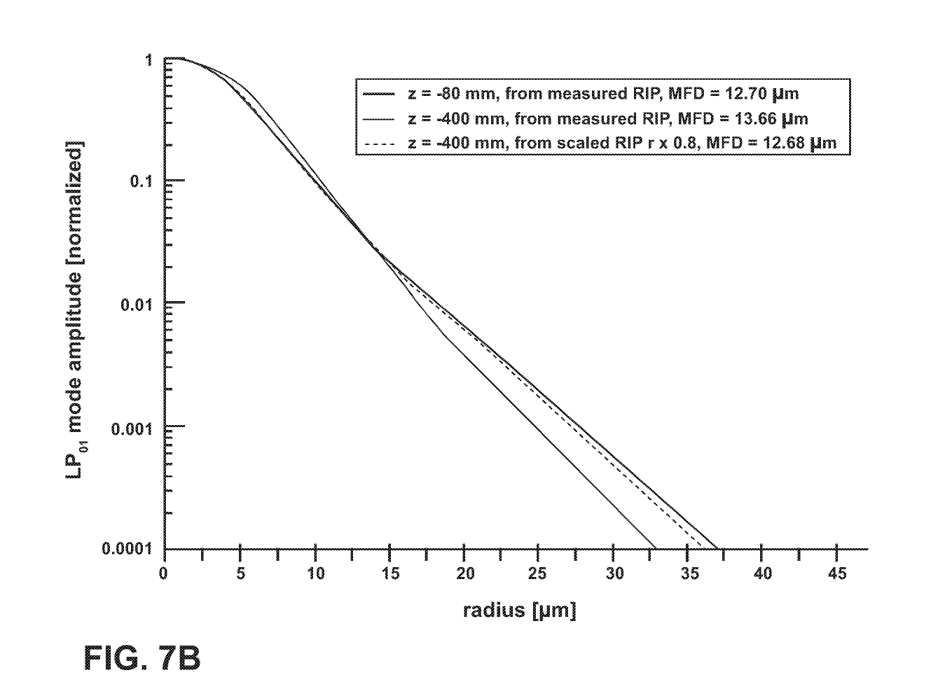

Referring now to FIGS. 7A and 7B, depicts a refractive index profile of an Corning® Vascade® EX3000 fiber at z=−400 micron (measured), corresponding to a nominal profile away from the taper, and of the profile in the tapered region at z=−80 micron (measured). The nominal profile with a radial axis scaled by a factor of 0.8 (scaled) represents the model index profile expected from geometric scaling of the fiber diameter in the taper. FIG. 7B shows the LP₀₁ mode field amplitude and MFDs computed for the profiles shown in FIG. 7A. The measured profile at z=−80 microns and the radially scaled model profile lead to similar MFDs (˜12.7 micron). For the Corning® Vascade® EX3000 fiber, the MFD change due to actual, measured change in the core radius and profile, and, due to the change in the profile, was computed in the model to be due solely to geometric scaling of the fiber diameter (FIG. 7A). While there is change in the actual core shape due to dopant diffusion, the change in the MFD from the taper edge (z=−400 micron) to close to the splice point (z=−80 micron) is similar for the measured and model index profiles, with MFD 12.7 μm near splice for both.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or numeral of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise.

What is claimed is:

1. An optical fiber connection, comprising:
a first optical fiber defining a first exterior surface and a first effective area, wherein the first fiber defines a first tapered region tapering from a first nominal fiber diameter to a first tapered diameter;
a second optical fiber having a second exterior surface and a second effective area less than the first effective area, wherein the second fiber defines a second tapered region tapering from a second nominal fiber diameter to a second tapered diameter; and
a fiber splice optically coupling the first tapered region of the first fiber to the second tapered region of the second fiber, wherein the first and second tapered regions taper such that the first and second exterior surfaces have a variance from a Gaussian function of less than 25% of the Gaussian function at each point along the first and second exterior surfaces of tapered regions.

2. The optical fiber connection of claim 1, wherein the first effective area of the first optical fiber is greater than 120 μm².

3. The optical fiber connection of claim 2, wherein the second effective area of the second optical fiber is less than 90 μm².

4. The optical fiber connection of claim 3, wherein the first tapered region has a minimum diameter which is less than 80% of the first nominal diameter of the first fiber.

5. The optical fiber connection of claim 4, wherein the minimum diameter of the first tapered region is less than 75% of the first nominal diameter of the first fiber.

6. The optical fiber connection of claim 4, wherein the minimum diameter of the first tapered region is axially offset from the fiber splice by a distance of 25 μm to 75 μm.

7. The optical fiber connection of claim 1, wherein light transmitted through the first and second optical fibers experiences a power loss less than 0.2 dB through the first and second tapered regions and the fiber splice.

8. The optical fiber connection of claim 1, wherein the Gaussian function of the first and second exterior surfaces has full width at half minimum in a range of 0.1 mm to 1.0 mm.

9. An optical fiber connection, comprising:
a first optical fiber defining a first exterior surface and a first effective area of greater than 120 μm², wherein the first fiber defines a first tapered region;
a second optical fiber defining a second exterior surface and a second tapered region, the second optical fiber having a second effective area of less than 90 μm²; and
a fiber splice optically coupling the first tapered region of the first fiber to the second tapered region of the second fiber, the first and second tapered regions tapering such that each of the first and second exterior surfaces define a portion of a substantially Gaussian function, wherein the Gaussian functions of the first and second exterior surfaces have different full widths at half minimum.

10. The optical fiber connection of claim 9, wherein the first optical fiber extends for a distance greater than 1 km.

11. The optical fiber connection of claim 9, wherein the full width at half minimum of the Gaussian function of the first exterior surface is greater than 200% of the full width at half minimum of the Gaussian function of the second exterior surface.

12. The optical fiber connection of claim 11, wherein the full width at half minimum of the Gaussian function of the first exterior surface is greater than 500% of the full width at half minimum of the Gaussian function of the second exterior surface.

13. The optical fiber connection of claim 9, wherein a minimum diameter of the first and second tapered regions is located at the fiber splice.

14. The optical fiber connection of claim 9, wherein a minimum diameter of the first and second tapered regions is axially offset from the fiber splice.

15. An optical fiber connection, comprising:
a first optical fiber defining a first exterior surface and a first effective area of greater than 120 μm², wherein the first fiber defines a first tapered region;
a second optical fiber defining a second exterior surface and a second tapered region, the second optical fiber having a second effective area of less than 90 μm²; and
a fiber splice optically coupling the first tapered region of the first fiber to the second tapered region of the second fiber, the first and second tapered regions tapering such that the first and second exterior surfaces have a variance from a single Gaussian function of less than 20% of the Gaussian function at each point along the first and second exterior surfaces, wherein the fiber splice is offset from a minimum diameter of the first tapering region.

16. The optical fiber connection of claim 15, wherein the first tapered region has a minimum diameter which is less than 80% of the first nominal diameter of the first fiber.

17. The optical fiber connection of claim 16, wherein the minimum diameter of the first tapered region is less than 75% of the first nominal diameter of the first fiber.

18. The optical fiber connection of claim 15, wherein the offset is greater than 30 μm from the fiber splice.

19. The optical fiber connection of claim 15, wherein the first optical fiber extends for a distance greater than 1 km.

20. The optical fiber connection of claim 15, wherein the first effective area of the first optical fiber is greater than 140 μm².
